(19) United States
(12) Patent Application Publication
(10) Pub. No.: US 2012/0042490 A1
(43) Pub. Date: Feb. 23, 2012

(54) METHOD OF PRE-DOPING LITHIUM ION INTO ELECTRODE AND METHOD OF MANUFACTURING ELECTROCHEMICAL CAPACITOR USING THE SAME

(75) Inventors: Sang Kyun LEE, Gyeonggi-do (KR); Ji Sung Cho, Gyeonggi-do (KR); Bae Kyun Kim, Gyeonggi-do (KR)

(73) Assignee: SAMSUNG ELECTRO-MECHANICS CO., LTD.

(21) Appl. No.: 12/967,800

(22) Filed: Dec. 14, 2010

(30) Foreign Application Priority Data
Aug. 19, 2010 (KR) 10-2010-0080297

(51) Int. Cl. H01G 9/042; H01M 4/04; H01G 9/15

(52) U.S. Cl. 29/25.03; 205/59

(57) ABSTRACT

The present invention provides a method of pre-doping lithium ions into an electrode, and a method of manufacturing an electrochemical capacitor using the same. The method for pre-doping lithium ions into an electrode includes the steps of: immersing a positive electrode, a negative electrode, and a lithium metal electrode into an electrolyte solution; performing a first pre-doping for directly doping lithium ions into the negative electrode from the lithium metal electrode; and performing a second pre-doping which includes a charging process for applying currents between the positive electrode and the negative electrode to charged with the applied currents, and a releasing process for releasing lithium ions from the lithium metal electrode, and a method for manufacturing the electrochemical capacitor using the same.

### CROSS-REFERENCE TO RELATED APPLICATIONS

This application claims the benefit under 35 U.S.C. Section [120, 119, 119(e)] of Korean Patent Application Serial No. 10-2010-0080297, entitled “Method Of Pre-Doping Lithium Ion Into Electrode And Method Of Manufacturing Electrochemical Capacitor Using The Same” filed on Aug. 19, 2010, which is hereby incorporated by reference in its entirety into this application.

### BACKGROUND OF THE INVENTION

1. Field of the Invention

The present invention relates to an electrochemical capacitor; and, more particularly, to a method of pre-doping lithium ions into an electrode, and a method of manufacturing an electrochemical capacitor using the same.

2. Description of the Related Art

In general, an electrochemical energy storage apparatus refers to a core component of finished products essentially used in electronic appliances. Also, the electrochemical energy storage apparatus is expected to be certainly used as a high-quality energy source in renewable energy fields applicable to future electric vehicles, portable electronic devices, and so on.

An electrochemical capacitor of electrochemical energy storage apparatuses may be classified into an electrical double layer capacitor using an electrical double layer principle and a hybrid super-capacitor using electrochemical oxidation-reduction reactions.

Herein, the electrical double layer capacitor is mainly used in a field requiring high-output energy characteristics, but it has a disadvantage such as low capacitance. On the contrary, the hybrid super-capacitor has been actively researched as an alternative solution for improving capacitance characteristics of the electrical double layer capacitor.

In particular, a Lithium Ion Capacitor LIC of hybrid super-capacitors may have a storage capacitance of three-four times larger than that of the electrical double layer capacitor by being structured with a negative electrode doped with lithium ions, so that it may have a large energy density.

Herein, in the process for pre-doping lithium ions into the negative electrode, lithium metal films are provided on the uppermost and lowermost layers of an electrode laminate, and then the resulting lithium metal films are immersed in an electrolyte solution. At this time, since the lithium metal films are provided on both ends of the electrode laminate, the lithium ions may be non-uniformly doped into the whole stacked negative electrode, and the lithium metal films may remain after completion of the pre-doping process. The lithium metals are extracted when the electrochemical capacitor is driven, which results in a reduction of the reliability of the electrochemical capacitor.

Also, it takes 20 days to uniformly dope lithium ions to the negative electrode inside the electrode laminate, which cause a difficulty to mass-production.

That is, the pre-doping process is necessarily subjected to the negative electrode for improving the capacitance characteristics of the electrochemical capacitor, which results in a reduction of the reliability and a limit to mass-production for the electrochemical capacitor.

Therefore, in order to implement mass-production of an electrochemical capacitor with a high capacitance, there is a need for a new pre-doping process which can uniformly and rapidly dope lithium ions into the negative electrode.

### SUMMARY OF THE INVENTION

The present invention has been proposed in order to overcome the above-described problems and it is, therefore, an object of the present invention to provide a method for pre-doping lithium ions into an electrode, in which lithium ions are directly doped into a negative electrode from a lithium metal electrode, and then a charging process and a releasing process are performed, thereby implementing the reliability and the mass-production, and a method for manufacturing an electrochemical capacitor.

In accordance with one aspect of the present invention to achieve the object, there is provided a method for pre-doping lithium ions into an electrode including the steps of: immersing a positive electrode, a negative electrode, and a lithium metal electrode into an electrolyte solution; performing a first pre-doping for directly doping lithium ions into the negative electrode from the lithium metal electrode; and performing a second pre-doping which includes a charging process for applying currents between the positive electrode and the negative electrode to charged with the applied currents, and a releasing process for releasing lithium ions from the lithium metal electrode.

Also, the step of performing the first pre-doping is performed by the short-circuit between the lithium metal electrode and the negative electrode.

Also, the step of performing the first pre-doping is performed by a charging process for applying currents between the lithium metal electrode and the negative electrode to be charged with the applied currents.

Also, the step of performing the first pre-doping is performed until an electrical potential level of the negative electrode is reduced from 3V to 0.8V.

Also, the releasing process for releasing lithium ions from the lithium metal electrode is performed by discharging between the lithium metal electrode and the positive electrode.

Also, the releasing process for releasing the lithium ions from the lithium metal electrode is performed by the short-circuit between the lithium metal electrode and the positive electrode.

Also, the charging process of the step of performing the second pre-doping is performed until the voltage between the positive electrode and the negative electrode reaches a value in a range from 3V to 4V.

Also, the releasing process in the step of performing the second pre-doping is performed until the voltage between the positive electrode and the lithium metal electrode reaches a value in a range from 2V to 3V.

Also, the method further includes a step of making the positive electrode and the lithium metal electrode short-circuited, after the step of performing the second pre-doping.

Also, the step of making the positive electrode and the lithium metal electrode short-circuited is performed until the voltage between the positive electrode and the lithium metal electrode reaches a value of 2V.

In accordance with another aspect of the present invention to achieve the object, there is provided a method for manufacturing an electrochemical capacitor including the steps of: forming an electrode cell which includes a positive electrode and a negative electrode alternately stacked with respect to a separator therebetween; receiving the electrode cell, the lithium metal electrode, and the electrolyte solution inside a housing; performing a first pre-doping for doping lithium ions directly into the negative electrode from the lithium metal electrode; performing a second pre-doping which includes a charging process for applying currents between the positive electrode and the negative electrode to be charged with the applied currents, and a releasing process for releasing the lithium ions from the lithium metal electrode; and sealing the housing.

Also, the step of performing the first pre-doping is performed by the charging process for applying currents between the lithium metal electrode and the negative electrode to be charged with the applied currents, or by the short-circuit process performed between the lithium metal electrode and the negative electrode.

Also, the releasing process for releasing lithium ions from the lithium metal electrode is performed by the charging between the lithium metal electrode and the positive electrode, or by the short-circuit performed between the lithium metal electrode and the positive electrode.

Also, the method further includes a step of making the positive electrode and the lithium metal electrode short-circuited, after the step of performing the second pre-doping.

Also, the housing is formed of an Al laminate film.

Also, the method further includes a step of pulling out the lithium metal electrode from the housing between the step of sealing the housing and the step of performing the second pre-doping which includes a charging process for applying currents between the positive electrode and the negative electrode to be charged with the applied currents, and a releasing process for releasing lithium ions from the lithium metal electrode.

Also, any one of the positive and negative electrodes is provided with a current collector with a plurality of holes.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 to 3 are schematic views showing a method for pre-doping lithium ions into an electrode in accordance with a first embodiment of the present invention, respectively; and;

FIGS. 4 to 7 are perspective views showing a process of manufacturing an electrochemical capacitor in accordance with a second embodiment of the present invention, respectively.

### DETAILED DESCRIPTION OF THE PREFERABLE EMBODIMENTS

Embodiments of an electrochemical capacitor in accordance with the present invention will be described in detail with reference to the accompanying drawings. When describing them with reference to the drawings, the same or corresponding component is represented by the same reference numeral and repeated description thereof will be omitted.

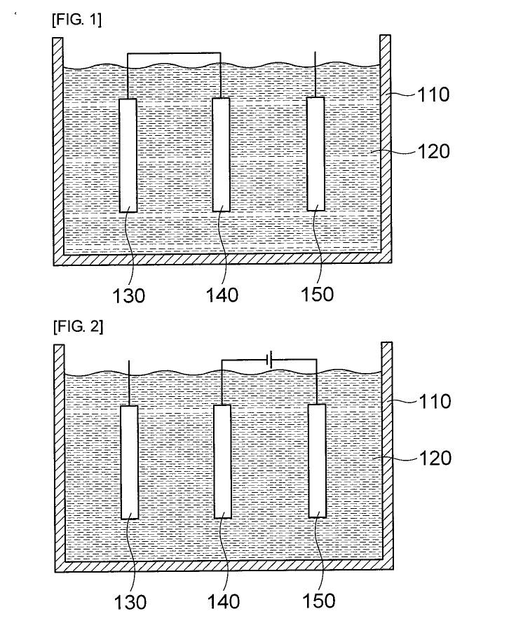

FIGS. 1 to 3 are schematic views showing a method for pre-doping lithium ions into an electrode in accordance with a first embodiment of the present invention, respectively.

Referring to FIG. 1, in order to pre-dope lithium ions into an electrode, a positive electrode 150, a negative electrode 140, and a lithium metal electrode 130 are immersed into an electrolyte solution 120 received in a housing 110.

Herein, the positive electrode 150 may include a positive active material layer capable of reversibly doping or un-doping ions. At this time, the positive active material layer may include a carbon material, for example, activated carbon.

Also, the negative electrode 140 may include a negative active material layer capable of reversibly doping or un-doping ions. Herein, the negative active material may include any one of natural graphite, artificial graphite, Mesophase pitch based carbon fiber (MCF), MesoCarbon MicroBead (MCMB), whisker, graphitized carbon fiber, non-graphitizable carbon, polyacene Organic semiconductor, carbon nanotube, carbon-graphite composite, furfuryl alcohol resin pyrolyzates, novolac resin pyrolyzates, condensed polycyclic hydrocarbon, such as pitch and cokes, or a mixture of two or more thereof.

The lithium metal electrode 130 plays a role of a supply source for supplying lithium ions pre-doped into the negative electrode 140, and may be made up of lithium or alloy including lithium.

The electrolyte solution 120 plays a role of a medium for transferring lithium ions. Herein, as for the electrolyte solution, the electrolyte solution already used in the electrochemical capacitor may be used without any change or in a different manner from the electrolyte solution already used in the electrochemical capacitor.

The electrolyte solution 120 may include electrolyte and a solvent. The electrolyte is in a salt state, including lithium salt, or ammonium salt. As for the solvent, nonprotic organic solvent. The solvent may be selectively used in consideration of electrolyte's solubility, reaction with the electrodes, viscosity, and available temperature range. As for the solvent, propylene carbonate, diethylene carbonate, ethylene carbonate, sulfolane, acetonitrile, dimethoxyethane, tetrahydrofuran, and ethylmethyl carbonate may be exemplified. Herein, the solvents may be used individually or in combination with one or more thereof. For example, the solvent may be used in combination with ethylene carbon, and ethylmethyl carbonate. At this time, the mix ratio of the ethylene carbonate and ethylene carbon may range from 1:1 to 1:2.

The positive electrode 150, the negative electrode 140, and the lithium metal electrode 130 are immersed into the electrolyte solution 120, and then a first pre-doping is performed to directly dope lithium ions into the negative electrode 140 from the lithium metal electrode 130.

Herein, the method for directly doping the lithium ions into the negative electrode 140 may be performed by a charging process for applying currents between the negative electrode 140 and the lithium metal electrode 130 to be charged with the applied currents. At this time, the lithium metal electrode 130 oxidizes, and thus the lithium ions may be produced. The resulting lithium ions may be transferred through the electrolyte solution 120 and doped into the negative electrode 140.

Alternatively, the method for directly doping lithium ions into the negative electrode 140 may be made by a short between the negative electrode 140 and the lithium metal electrode 130. At this time, an electrical potential difference occurs between the negative electrode 140 and the lithium metal electrode 130, so that it is possible to naturally dope the lithium ions of the lithium metal electrode 130 into the negative electrode 140. At this time, as the negative electrode 140 and the lithium metal electrode 130 are made short-circuited, the doping process therebetween may be faster performed than the charging process. Also, it is possible to easier perform a process since it is unnecessary to use an external power source.

As such, in the first pre-doping process, lithium ions are directly doped into the negative electrode 140 from the lithium metal electrode 130, so that it is possible to increase a process speed. Herein, the first pre-doping process may be performed until an electrical potential of the negative electrode 140 is reduced from 3V to 0.8 V. This is because as the electrical potential level of the negative electrode 140 is reduced below 0.8V, a doping process time taken for doping lithium ions into the negative electrode from the lithium metal electrode 130 may be rapidly increased.

Also, when the lithium ions are doped into the negative electrode 140 by using the first pre-doping process alone, it may take a longer time to perform the doping process, and thus it is impossible to implement mass-production, and uniform doping of lithium ions into the negative electrode 140.

Referring to FIGS. 2 and 3, after the first pre-doping process is performed, a second pre-doping process is performed to uniformly dope lithium ions into the negative electrode 140.

The second pre-doping process may include a charging process (see FIG. 2) made by applying currents between the positive electrode 150 and the negative electrode 140 to be charged with the applied currents, and a releasing process where the lithium ions are released from the lithium metal electrode 130 (see FIG. 3). Herein, the charging and releasing processes may be repeatedly performed several times until the doping amount of the lithium ions into the negative electrode 140 reaches a preset value.

Herein, the charging process may be performed until the voltage between the positive electrode 150 and the negative electrode 140 reaches a value of 3V to 4V, in consideration of a condition where it is possible to prevent decomposition of the electrolyte solution 120. For example, in case where the charging process is performed until the voltage between the positive electrode 150 and the negative electrode 140 reaches a value of 4V, the lithium ions contained in the electrolyte solution 120 or the positive electrode 150 may be doped into the negative electrode 140.

The releasing process may be performed by the discharging between the lithium metal electrode 130 and the positive electrode 150. Herein, in case where the lithium metal electrode 130 and the positive electrode 150 are discharged, the positive electrode 150 releases negative ions and thus have a reduced potential value. Also, the lithium metal electrode 130 oxidizes and thus lithium ions may be produced. That is, discharging between the lithium metal electrode 130 and the positive electrode 150 may make lithium ions released to the electrolyte solution.

The releasing process may be performed until the voltage between the positive electrode 150 and the lithium metal electrode 130 reaches a value of 2V to 3V, for example, 2.8V, in consideration of the oxidation of the lithium metal electrode 130.

Alternatively, the releasing process may be performed by a short-circuit process for making the positive electrode 150 and the lithium metal electrode 130 short-circuited. In case where the positive electrode 150 and the lithium metal electrode 130 are made short-circuited, the lithium ions may be doped directly into the positive electrode without diffusion to the electrolyte solution.

Herein, the charging/releasing process may be repeatedly performed several times until the electrical potential level of the negative electrode reaches a preset value.

As such, through the charging/releasing process, the doping amount of lithium ions can be controlled, and thus the lithium ions may be uniformly doped into the negative electrode 140.

In addition, a step of making the positive electrode 150 and the lithium metal electrode 130 short-circuited may be further included. Herein, the short-circuit process may be performed until the voltage between the positive electrode 150 and the lithium metal electrode 130 reaches a value of 2V or lower. That is, the electrical potential level of the positive electrode 150 and the lithium metal electrode 130 may be reduced from 3V to 2V. That is, as the potential level of the positive electrode 150 becomes low, the amount of lithium ions into the negative electrode 140 may be increased, and thus energy density of the electrochemical capacitor may be increased as well.

Herein, in case where the potential level of the positive electrode 150 is higher than 2V, the amount of the lithium ions into the negative electrode 140 is reduced, and thus the energy density of the electrochemical capacitor may be reduced as well.

Therefore, as in the embodiment of the present invention, in order to pre-dope lithium ions into the negative electrode 140, doping time may be shorten through the primary pre-doping process, and through a secondary pre-doping, the negative electrode may be uniformly doped with the lithium ions.

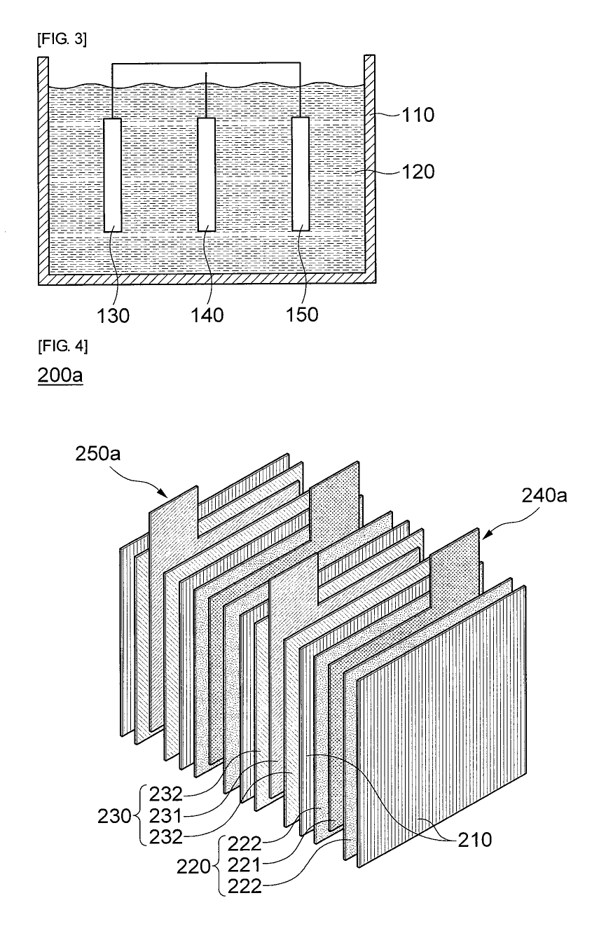

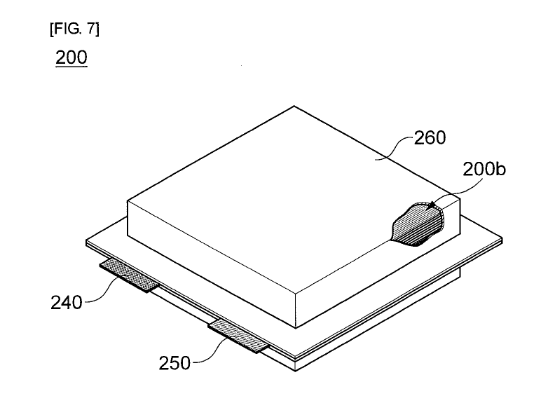

FIGS. 4 to 7 are perspective views showing a process of manufacturing the electrochemical capacitor in accordance with a second embodiment of the present invention, respectively.

Referring to FIG. 4, in order to manufacture the electrochemical capacitor 200, a positive electrode 220 and a negative electrode 230 are sequentially stacked with respect to a separator 210 formed therebetween to thereby form a preliminary electrode cell 200a.

In addition, the separator 210 may further be provided on the outmost layer of the preliminary electrode cell 200a. In particular, the separator 210 may play a role of electrically separating the negative electrode 230 and the positive electrode 220. The separator 210 may be a paper or a nonwoven, but the present invention is not limited to the kind of the separator 210.

The positive electrode 220 may include a positive current collector 221, and positive active material layers 222 which are disposed on each surface of the positive current collector 221. Herein, the positive electrode 220 may include a positive terminal 240a which is electrically connected to the positive current collector 221. At this time, the positive current collector 221 and the positive terminal 240a may be formed in a body.

Also, the positive current collector 221 may be made of any one of aluminum, stainless, copper, nickel, titanium, tantalum, and niobium. The positive current collector 221 may be formed to have a thickness with a range of 10 to 300 μm. Also, the positive current collector 221 may be in a thin-film shape, but the positive current collector 221 may be provide with a plurality of through holes for effectively transferring ions and performing uniform doping process.

Also, the positive active material layers 222 may include a carbon material (i.e., activated carbon) capable of reversibly doping or un-doping ions. In addition, the positive active material layers 222 may further include a binder. Herein, the material of the binder may include at least one of fluoro-polymer resin like polytetrafluoroethylene (PTFE) and poly(vinylidene fluoride) (PVdf), thermoplastic resin like polyimide, polyamideimide, polyethylene (PE), and polypropyrene (PP), cellulosic resin like carboxymethylcellulose (PDMS), a rubber resin like styrene butadiene rubber (SBR), ethylene/propylene/diene copolymer (EPDM), polymethacrylic acid (PDMS), and poly vinyl pyrrolidone (PVP). Also, the positive active material layer 222 may further include conductive material, for example, carbon black and solvent.

Herein, in order to form the positive electrode 220, the positive active material layers 222 are manufactured to be in a sheet type, and then the positive active material layers 222 and the positive current collector 221 are attached by using a conductive adhesive. Alternatively, in order to form the positive electrode 220, the positive active material is formed on the positive current collector 221 by use of a slurry, to form the positive active material layer 222 through a coating scheme, for example, a doctor blade method, thereby manufacturing the positive electrode 220.

The negative electrode 230 may include a negative current collector 231, and a negative active material layers 232 which are disposed at each surface of the negative current collector 231.

Herein, the negative electrode 230 may include a negative terminal 250a which is electrically connected to the negative current collector 231. At this time, the negative current collector 231 and the negative terminal 250a may be formed in a body.

Also, the negative current collector 231 may include metal, for example, any one of Cu, Ni and stainless. The negative current collector 231 may be in a thin-film shape, but the negative current collector 231 may include a plurality of through holes for effectively transferring ions and uniformly performing a doping process.

Also, the negative active material layer 232 may include a carbon material capable of reversibly doping or un-doping lithium ions. The negative active material layer may include any one of natural graphite, artificial graphite, Mesophase pitch based carbon fiber (MCF), MesoCarbon MicroBead (MCMB), whisker, graphitized carbon fiber, non-graphitizable carbon, polyacene Organic semiconductor, carbon nanotube, caborn-graphite composite, furfuryl alcohol resin pyrolyzates, novolac resin pyrolyzates, condensed polycyclic hydrocarbon, such as pitch and cokes, or a mixture of two or more thereof.

Herein, the negative electrode 230 may be formed in the same manner as in the above-described positive electrode 220, so the description thereof will be omitted for clarity of illustration.

Although it has been shown in the embodiment of the present invention that the negative electrode 230 and the positive electrode 220 are stacked twice, the present invention is not limited thereto.

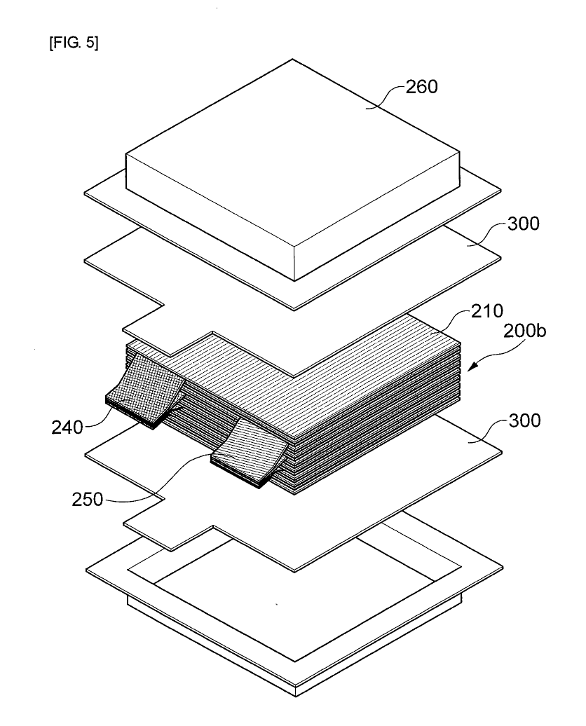

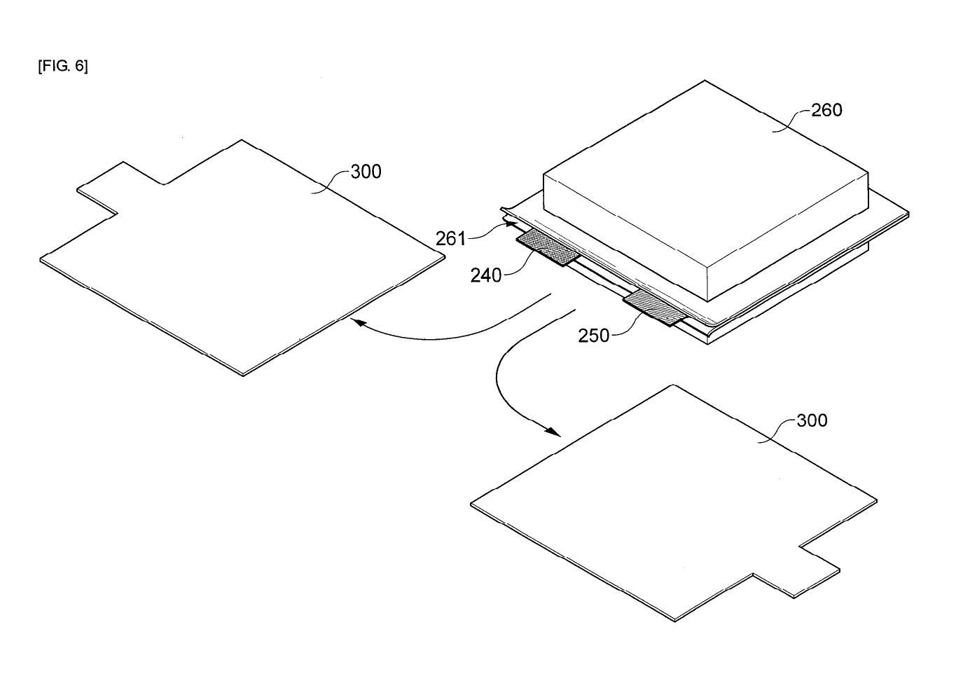

Referring to FIG. 5, the positive terminal 240a and the negative terminal 250a of the preliminary electrode cell 200a are welded respectively to thereby form an electrode cell 200b which includes the positive terminal part 240 and the negative terminal part 250. Herein, the welding process may be performed by a ultrasound welding, but the present invention is not limited thereto.

Thereafter, the inside of the housing 260 is provided with the electrode cell 200b and the lithium metal electrodes 300 disposed on both sides of the electrode cell 200b. Although it has been illustrated in the embodiment of the present invention that two lithium metal electrodes 300 may be formed, the present invention is not limited thereto. Alternatively, one or at least three lithium metal electrodes may be formed, and the present invention is not limited thereto.

A detailed description will be given of a method for receiving the electrode cell 200b and the lithium metal electrodes 300 inside the housing, with reference to FIG. 6. The housing 260 may be formed of an Al laminate film. In order to package the electrode cell 200b, two aluminum laminate films are subjected to a thermal fusion process with respect to the electrode cell 200b and the lithium metal electrode 300 interposed therebetween, thereby forming the housing 260. Herein, the thermal fusion process is not subjected to the opening 261 which is to be used for inputting and the electrolyte solution and for pulling out the lithium metal electrode 300.

Thereafter, the electrolyte solution is filled through the opening in such a manner that the filled solution receives electrode cell 200b and the lithium metal electrode 300. Herein, the electrolyte solution may include electrolyte and a solvent. The electrolyte is in a salt state, including lithium salt, or ammonium salt. As for the solvent, nonprotic organic solvent may be used. The solvent may be selectively used in consideration of electrolyte's solubility, reaction with the electrodes, viscosity, and available temperature range. As for the solvent, propylene carbonate, diethylene carbonate, ethylene carbonate, sulfolane, acetonitrile, dimethoxyethane, tetrahydrofuran, and ethylmethyl carbonate may be exemplified. Herein, the solvent may be used individually or in combination with one or more thereof. For example, the solvent may be used in combination with ethylene carbon, and ethylmethyl carbonate. At this time, the mix ratio of the ethylene carbonate and ethylene carbon may range from 1:1 to 1:2.

Thereafter, the pre-doping process for pre-doping lithium ions into the negative electrode 230 is performed. The process for pre-doping lithium ions into the negative electrode 230 may include a first pre-doping process for improving the doping process speed, and a second pre-doping process for uniformly doping lithium ions into the negative electrode 230, as described above.

Herein, in the first pre-doping process, lithium ions are directly doped into the negative electrode 230 from the lithium metal electrode 300. At this time, the first pre-doping process may be performed by a charging process or a short-circuit process. In the charging process, currents are applied between the lithium metal electrode 300 and the negative electrode 230 so as to be charged with the applied currents. In the short-circuit process, the lithium metal electrode 300 and the negative electrode 230 are made short-circuited.

Also, the second pre-doping process may be performed by performing the charging process for applying currents between the positive electrode 220 and the negative electrode 230 to be charged with the applied currents, and the releasing process for releasing lithium ions from the lithium metal electrode 300. At this time, the charging/releasing processes may be repeatedly performed several times until the doping amount of lithium ions doped into the negative electrode 230 reaches the set value.

In addition, a process for making the positive electrode 220 and the lithium metal electrode short-circuited may be further performed. At this time, as the lithium ions are doped into the positive electrode 220, the energy density of the electrochemical capacitor 200 may be improved.

After the pre-doping process of the negative electrode 230 has been completed, if the lithium metal electrode 300 remains without any consumption, the lithium metal electrode is pulled from the housing 260. Thus, since the lithium metal electrode 300 remains inside the housing 260, it is possible to prevent the lithium ions from being extracted to the negative electrode 230 or the positive electrode 220 of the outermost layers of the electrode cell 200b, and thus to secure the reliability of the electrochemical capacitor 200.

Referring to FIG. 6, the pre-doping process is performed for the negative electrode 230, and then the opening 261 of the housing 260 is vacuum-sealed.

Herein, although it has been illustrated in the embodiment of the present invention that the electrolyte solution is used as has been filled at the time of performing the pre-doping process, the present invention is not limited thereto. That is, in case where the electrolyte solution used in the pre-doping process of lithium ions is a material capable of generating electrolysis at a high voltage, before the opening 261 of the housing 260 is sealed, the electrolyte solution having been used in the pre-doping process may be emitted, and a new electrolyte solution may be inputted.

As in the embodiment of the present invention, by the secondary pre-doping process, lithium ions are doped into the negative electrode 230, thereby uniformly and rapidly doping lithium ions into the negative electrode 230. Therefore, it is possible to secure the mass-production and the reliability of the electrochemical capacitor 200.

Also, the pre-doping process of the negative electrode 230 is completely performed, and then a process for pulling out the lithium metal electrode 300 may be further performed, thereby preventing the reliability of the electrochemical capacitor 200 from being lowered due to the emission of the lithium metal to the inside.

Also, the pre-doping process of the negative electrode 230 may be performed within the housing, so that it is unnecessary to provide a glove box for performing the pre-doping process of the negative electrode 230, and thus to decrease the investment of production facilities, which results in a reduction of production's cost of the electrochemical capacitor.

Also, as the negative electrode 230 and the positive electrode 220 include current collectors with holes, through which lithium ions may be uniformly doped into the negative electrode 230, it is possible to improve reliability and lifetime of the electrochemical capacitor.

Hereinafter, a detailed description will be given of a method for pre-doping lithium ions into the electrodes and an electrochemical capacitor 200 using the method, through the experimental examples.

In the experimental example, cells' manufacture and the pre-doping process were performed in the argon glove box at less than −60° C., and the charging process of the pre-doping process were performed until the constant current voltage reaches a predetermined voltage of 3.8V, whereas the pre-doping process was performed until the constant current voltage reaches a predetermined voltage of 2V.

Formation of Positive Electrode

As for the positive active material, activated carbon with a specific space area of about 2200 m²/g formed by steam activation was used. The activated carbon powder, acetylene black, polyvinylidene fluorine were mixed at a weight ratio of 80:10:10, so as to form a mixture. Thereafter, the resulting mixture was added to methylpyrrolidone (NMP), and then stirred with each other, to prepare a slurry. Thereafter, the resulting slurry was coated and semi-dried on an Al thin-film by a doctor blade method, and then cut into a size of 10 cm×10 cm, to manufacture a positive electrode. At this time, the thickness of the positive electrode was about 60 μm. Before an electrode cell was manufactured, the positive electrode was dried under vacuum conditions at 120° C., for 10 hours.

Formation of Negative Electrode

As the negative active material, graphite, acetylene black, and polyvinylidene fluorine were mixed at a weight ration of 8:1.3:0.7 to thereby form a mixture. Thereafter, after the resulting mixture was added to methylpyrrolidone (NMP), and stirred with each other, to prepare a slurry. Thereafter, the slurry was coated, dried, and pressed on a copper to thereby form a sheet with a thickness of 25 μm, and then the resulting sheet was cut into a size of 10 cm×10 cm, to manufacture a negative electrode.

Formation of Electrochemical Capacitor

The positive electrode and the negative electrode faced each other with respect to a separator therebetween to thereby manufacture a pair of electrodes. Thereafter, the positive electrode had an Al welded thereon, and the negative electrode had an Ni welded thereon, to thereby form an electrode cell. Meanwhile, LiPF₆ was dissolved in a mixed solvent prepared by mixing ethylene carbon, propylene carbonate, and diethylene carbonate at a weight ratio of 3:1:4, to prepare an electrolyte solution. The electrode cell and the electrolyte solution were sealed in the Al laminate film. Thereafter, through the above-described pre-doping process, the doping amount of lithium ions into the negative electrode was 90% of the negative electrode, and then short-circuit was made until the voltage between the positive electrode and the lithium metal electrode reaches a value of 2V. After completion of the doping process, the lithium metal electrode was pulled out of the Al laminate film, and then the Al laminate film was sealed.

Performance's Evaluation of Electrochemical Capacitor: High-Temperature Cycle Test

Constant currents are charged so that a predetermined voltage reaches a value of 3.8V, within a constant temperature bath of 60° C., for 900 seconds, and were discharged that the predetermined voltage reaches a value of 2.0V, and then after passage of 10 seconds, the following charging/discharging were repeatedly performed,

This charging/discharging was referred to as one cycle. After repeating the charging/discharging in 1000 cycle, and the capacitance of the electrochemical capacitor was acquired. After repeatedly performing charging/discharging of 1000 cycles, its capacitance maintenance rate was 97%, and the beginning capacitance was 510 F.

As such, in the electrochemical capacitor in accordance with the embodiment of the present invention, it was possible to acquire a superior and larger capacitance at a cycle of 60° C. at a high voltage in a range from 3.9V to 2.0. Thus, by the secondary pre-doping process, lithium ions were doped into the negative electrode, thereby improving energy density, and securing the reliability.

In the method for pre-doping the electrode in accordance with an embodiment of the present invention, the lithium ions are primarily doped into the negative electrode to thereby shorten the doping time. Thereafter, by performing the charging/releasing process of the lithium ions, the lithium ions may be uniformly doped into the negative electrode, so that it is possible to shorten the pre-doping time of the negative electrode. Simultaneously with this, it is possible to uniformly dope the lithium ions into the negative electrode.

Also, the lithium ions can be rapidly doped into the negative electrode, so that it is possible to manufacture an electrochemical capacitor with a high capacitance, as well as to secure the reliability and mass-production.

Also, the pre-doping process of the electrodes may be performed inside the housing which receives the electrode cell, so that it is unnecessary to provide a separate glove box for the pre-doping process of the electrode, which results in a reduction of process' cost of the electrochemical capacitor.

Also, the current collector of the electrodes are provided with holes, so that it is possible to uniformly dope the lithium ions into the electrode, which results in an improvement of the lifetime of the electrochemical capacitor.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A method of pre-doping lithium ions into an electrode comprising:
immersing a positive electrode, a negative electrode, and a lithium metal electrode into an electrolyte solution;
performing a first pre-doping for directly doping lithium ions into the negative electrode from the lithium metal electrode; and
performing a second pre-doping which includes a charging process for applying currents between the positive electrode and the negative electrode to charged with the applied currents, and a releasing process for releasing lithium ions from the lithium metal electrode.

2. The method of pre-doping lithium ions into an electrode according to claim 1, wherein performing the first pre-doping is performed by short-circuit between the lithium metal electrode and the negative electrode.

3. The method of pre-doping lithium ions into an electrode according to claim 1, wherein performing the first pre-doping is performed by a charging process for applying currents between the lithium metal electrode and the negative electrode to be charged with the applied currents.

4. The method of pre-doping lithium ions into an electrode according to claim 1, wherein performing the first pre-doping is performed until an electrical potential level of the negative electrode is reduced from 3V to 0.8V.

5. The method of pre-doping lithium ions into an electrode according to claim 1, wherein the releasing process for releasing lithium ions from the lithium metal electrode is performed by discharging between the lithium metal electrode and the positive electrode.

6. The method of pre-doping lithium ions into an electrode according to claim 1, wherein the releasing process for releasing the lithium ions from the lithium metal electrode is performed by short-circuit between the lithium metal electrode and the positive electrode.

7. The method of pre-doping lithium ions into an electrode according to claim 1, wherein the charging process of performing the second pre-doping is performed until the voltage between the positive electrode and the negative electrode reaches a value in a range from 3V to 4V.

8. The method of pre-doping lithium ions into an electrode according to claim 1, wherein the releasing process in performing the second pre-doping is performed until the voltage between the positive electrode and the lithium metal electrode reaches a value in a range from 2V to 3V.

9. The method of pre-doping lithium ions into an electrode according to claim 1, further comprising making the positive electrode and the lithium metal electrode short-circuited, after performing the second pre-doping.

10. The method of pre-doping lithium ions into an electrode according to claim 9, wherein making the positive electrode and the lithium metal electrode short-circuited is performed until the voltage between the positive electrode and the lithium metal electrode reaches a value of 2V.

11. A method of manufacturing an electrochemical capacitor comprising:
forming an electrode cell which includes a positive electrode and a negative electrode alternately stacked with respect to a separator therebetween;
receiving the electrode cell, the lithium metal electrode, and the electrolyte solution inside a housing;
performing a first pre-doping for doping lithium ions directly into the negative electrode from the lithium metal electrode;
performing a second pre-doping which includes a charging process for applying currents between the positive electrode and the negative electrode to be charged with the applied currents, and a releasing process for releasing the lithium ions from the lithium metal electrode; and
sealing the housing.

12. The method of manufacturing an electrochemical capacitor according to claim 11, wherein performing the first pre-doping is performed by the charging process for applying currents between the lithium metal electrode and the negative electrode to be charged with the applied currents, or by the short-circuit process performed between the lithium metal electrode and the negative electrode.

13. The method of manufacturing an electrochemical capacitor according to claim 11, wherein the releasing process for releasing lithium ions from the lithium metal electrode is performed by the charging between the lithium metal electrode and the positive electrode, or by the short-circuit performed between the lithium metal electrode and the positive electrode.

14. The method of manufacturing an electrochemical capacitor according to claim 11, further comprising making the positive electrode and the lithium metal electrode short-circuited, after performing the second pre-doping.

15. The method of manufacturing an electrochemical capacitor according to claim 11, wherein the housing is formed of an Al laminate film.

16. The method of manufacturing an electrochemical capacitor according to claim 11, further comprising pulling out the lithium metal electrode from the housing between sealing the housing and performing the second pre-doping which includes a charging process for applying currents between the positive electrode and the negative electrode to be charged with the applied currents, and a releasing process for releasing lithium ions from the lithium metal electrode.

17. The method of manufacturing an electrochemical capacitor according to claim 11, wherein any one of the positive and negative electrodes is provided with a current collector with a plurality of holes.
